(19) United States
(12) Patent Application Publication
(10) Pub. No.: US 2006/0180708 A1
(43) Pub. Date: Aug. 17, 2006

(54) R/C cockpit

(76) Inventor: Victor Fontenot JR., Mandeville, LA (US)

Correspondence Address: VICTOR FONTENOT JR., 2335 ORLEANS ST., MANDEVILLE, LA, 70448, US

(21) Appl. No.: 11/057,679

(22) Filed: Feb. 14, 2005

(51) Int. Cl. B64C 13/04

(52) U.S. Cl. 244/234

(57) ABSTRACT

This invention allows a radio controlled aircraft; fixed-wing or rotary-wing, to be flown in a realistic manner, from a ground based cockpit with the use of controls like that of a full-size aircraft. These controls are attached to a radio control transmitter via mechanical linkages.

### RELATED APPLICATIONS

This invention relates to the on ground and in-flight control of radio controlled aircrafts by the use of a radio transmitter in which the control gimbals of the transmitter are attached to control levers that function in the same manner as a full-size aircraft.

### STATEMENT OF FEDERALLY SPONSORED RESEARCH/DEVELOPMENT

“Not Applicable”

### SEQUENCE LISTING

“Not Applicable”

### BACKGROUND

There are basically two different types of radio controlled aircraft, fixed-wing, which consist of small trainer planes to turbine-powered jets, and rotary-wing which are helicopters and gyro-copters. These aircraft are controlled by a hand held transmitter, which in no way simulates actual cockpit operations. Thus a control mechanism that duplicates a real cockpit experience is needed.

Several devices to overcome the problem have been invented. For instance the following patent numbers; U.S. Pat. No. 4,386,914; U.S. Pat. No. 4,464,116; U.S. Pat. No. 5,129,826; U.S. Pat. No. 5,878,981 and U.S. Pat. No. 6,331,114.

None of these known devices offer the advantages of the present invention, which will become apparent in the attached objects and appended claims.

### BRIEF SUMMARY OF THE INVENTION

The object of this invention is to provide for the average radio control modeler a safe and inexpensive way to achieve the feeling of flying a radio controlled aircraft in a real cockpit enviroment. The individual flight controls of this invention allows a pilot the means to fly a model without having to hold the transmitter in his or her hands.

### BRIEF DESCRIPTION OF THE DRAWINGS

FIG. 1 is a side view of the R/C Cockpit with its related controls.

FIG. 2 is a front view of the rudder systems primary control arm.

FIG. 3 is a side view of the unique rotary wing to fixed wing throttle conversion unit with attaching connector rod. This one of a kind unit with allows a pilot to convert aircraft throttle controls with a minimum of effort and time.

FIG. 4 is a view of the rudder systems secondary control arm with connecting rod to the radio transmitter throttle-rudder gimbal.

FIG. 5 is a view of the rudder-throttle control pivot plate with connecting arm attached to the secondary push rod which controls the throttle position.

FIG. 6 is a front view of the rudder pedals and associated parts. The rudder pedals control the steering and turning capabilities of an airplane, on a helicopter, the rudder pedals are used to counter-act the torque produced by the main rotor blades when different degrees of positive and negative pitch are applied to the blades. The rudder pedals in a helicopter also allow the pilot to rotate the body of the helicopter 360 degrees while in a hover or in slow forward or backward flight.

FIG. 7 is a side view of the primary (17A & 17B) throttle control rod connected to the throttle control rod swing arm (16A) and the rotary wing throttle/collective handle (20C), this handle controls the throttle and rotor blade pitch when the cockpit is in helicopter mode.

### DETAILED DISCRIPTION OF THE INVENTION

Referring to FIG. 1 plastic seat 22 was mounted to wooden seat frame 23 which was built onto base 25. Base supports 27A, 27B, & 27C where attached to the underside of base 25 to prevent contact with the ground. Furniture rollers 24 are attached to 27C so that the R/C Cockpit can be moved from point A to point B with minimum effort. Transmitter pod beam 26A was mounted onto base 25 then secured with beam bracket 26B. Transmitter tray 1 was then mounted onto transmitter pod beam 26A. Transmitter tray 1 is used to hold the radio control transmitter instead of it being hand held while flying a radio controlled model aircraft. Control yoke 2A was mounted to base 25 between seat 22 and transmitter pod beam 26A. Control yoke 2A is used to control the left, right, climb and decent of a fixed-wing aircraft and the left, right, forward and backward movement of a rotary-wing aircraft.

Control yoke 2A was connected to the transmitter gimbal with ¼ inch copper tubing 2B, so when control yoke 2A is moved, the transmitter gimbal will also move in the same direction and the same distance. Safety cable 28 was then attached to pod beam 26A and control yoke 2A. This cable is used to prevent the transmitter gimbal from being damaged due to over extension. Vinyl tubing 6 was attached to the bottom of transmitter tray 1. This tubing is used to apply tension to the secondary rudder cables 7A and 7B, so that they will function when the throttle control pivot plate 4A is in the low throttle position.

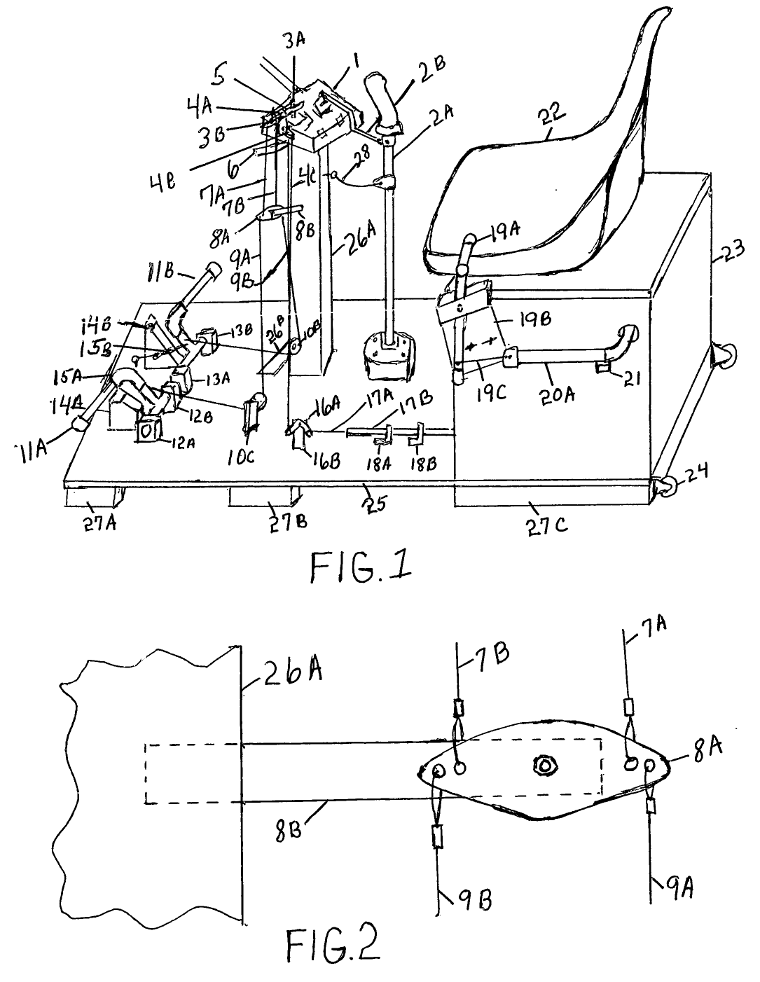

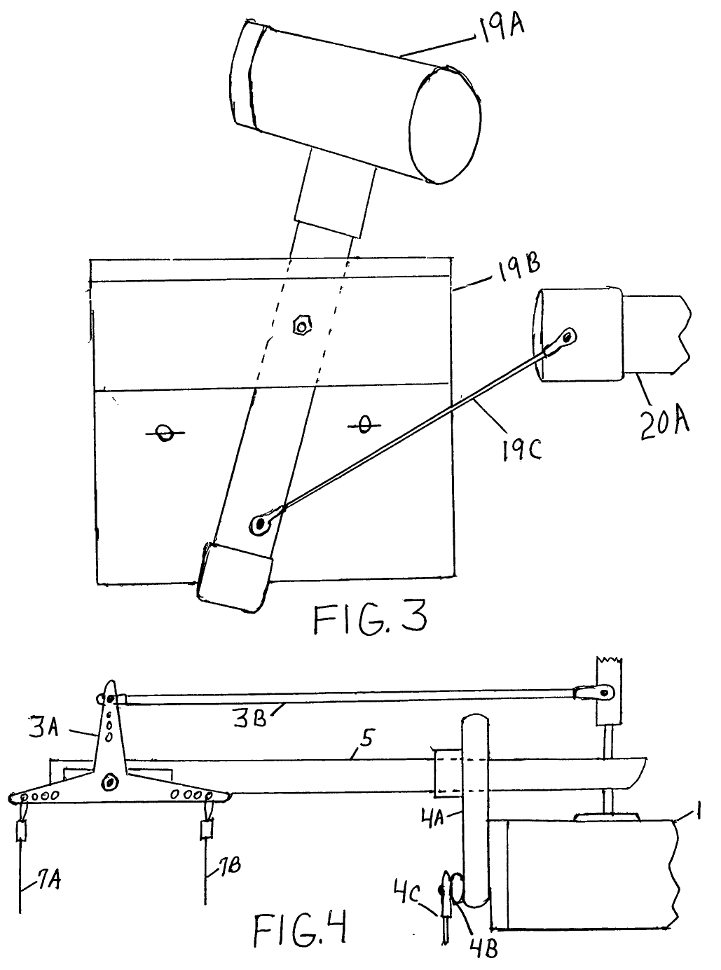

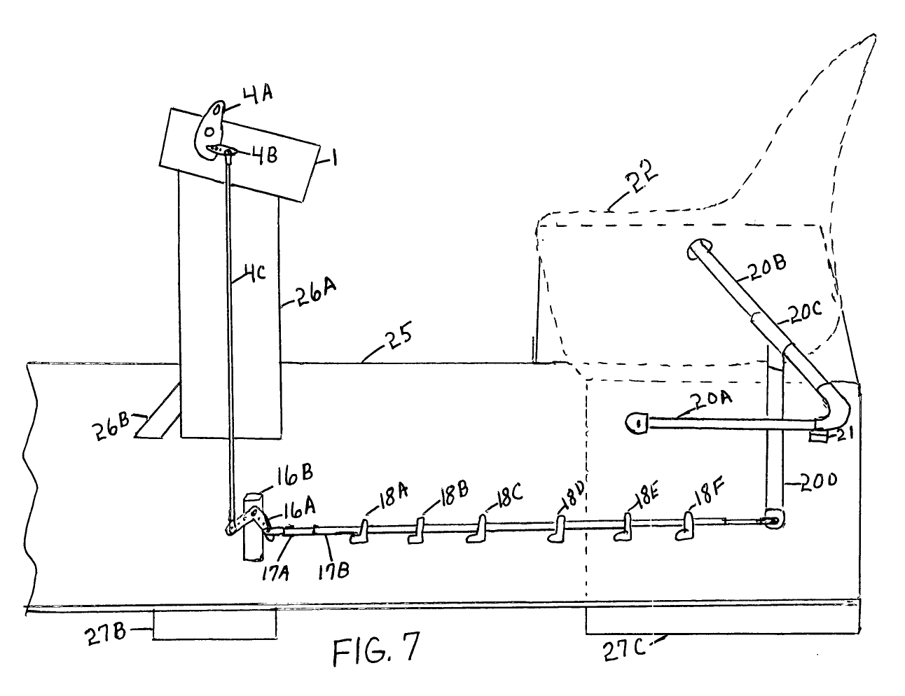

FIG. 2 shows a front view of primary rudder control arm 8A which is attached to mounting dowel 8B. Primary control cables 9A & 9B, secondary control cables 7A & 7B are also shown. These cables will be discussed later in FIG. 6. FIG. 3 is the unique throttle control conversion assembly 19A, B, & C.

This assembly is unique because it provides the means for the R/C Cockpit to be converted from helicopter mode (rotary-wing) to airplane mode (fixed-wing) in a simple and quick way with just the use of two bolts and wing nuts. Once the assembly is attached to seat frame 23, the next step is to attach a simple control rod with ball joints 19C to the conversion unit and the helicopter throttle-collective handle 20A.

FIG. 4 consist of the secondary rudder cable control arm 3A which is attached to the pivot arm 5. This arm passes through the pivot plate 4A. A slot on the end of pivot arm 5 is fitted around the throttle/rudder gimbal of a radio control transmitter. The control arm to gimbal connector rod 3B is then attached. This allows the transmitter gimbal to be moved to any desired position, full left or right rudder, open or closed throttle.

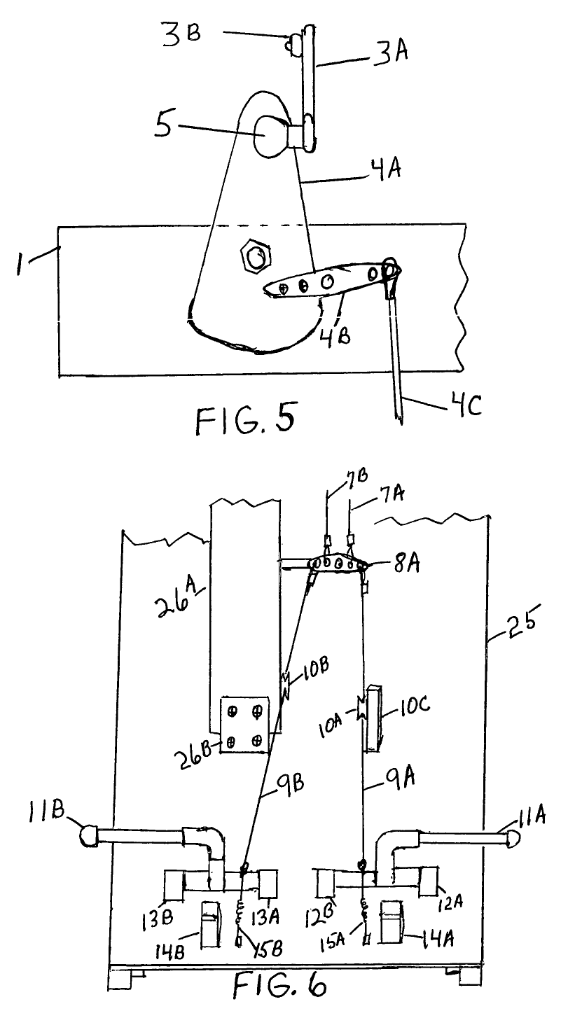

FIG. 5 is the pivot plate 4A with attached control arm 4B, and secondary throttle-collective control rod 4C, (which will be covered in detail in FIG. 7). The pivot plate rotates forward and backwards which in turn moves the pivot arm, which moves the radio controlled transmitter gimbal thus increasing or decreasing the throttle of the model aircraft.

FIG. 6 is a frontal view of the R/C Cockpits rudder system. 7A & 7B are the secondary cables which connect the primary 8A and secondary 3A control arms. 9A and 9B are the primary control cables. They connect the foot pedals 11A and 11B to the primary control 8A. These cables ride on rollers 10A and 10B. This is called a pull-pull system. When foot pedal 11A is pressed forward it pulls the radio control transmitter gimbal to the left, which causes the aircraft to yaw to the left. When foot pedal 11B is pressed forward it moves the gimbal to the right which applies right yaw to the aircraft.

Cable roller 10A is attached to mounting block 10C which is secured to base 25. Mounting blocks 12A, 12B, 13A and 13B hold the rudder pedals in position. They are attached to base 25. 15A and 15B are automotive carburator helper springs. These springs are used to assist in returning the rudder pedals to a neutral position. 14A and 14B are wooden blocks which are used to restrict the forward movement of the rudder pedals 11A and 11B to a certain point as to prevent the radio control transmitter gimbal from being overextended or damaged.

FIG. 7 is a side view of the R/C Cockpit throttle/collective system. Sections 20B are attached to a ¾ inch pvc T-joint 20C. Sections 20B are supported by holes in the sides of the seat frame 23. These holes allows sections 20B to rotate. The handle 20A is attached to 20B by a pvc elbow, which is supported by a wooden triangle brace 21. The function of brace 21 is to limit the downward travel of handle 20A. Vertical section 20D is attached to t-joint 20C. The primary control rod sleeve 17B is secured to mounting brackets 18A through 18F, which are secured to base 25. Primary control rod 17A is passed through control rod sleeve 17B and attached to vertical section 20D and the throttle control rod swing arm 16A with ball-joints. Throttle control rod swing arm 16A is mounted to the throttle control swing arm bracket 16B, which is secured to base 25.

Secondary control rod 4C is attached to the throttle control swing arm 16A and pivot plate arm 4B. The system functions in the following manner; when the throttle-collective handle 20A is raised upward, (as it would be in the cockpit of a full-size helicopter), it rotates 20B which causes 20D to move forward, which moves primary control rod 17A forward, which in turn pushes throttle control swing arm 16A forward, which pushes secondary throttle control rod 4C upward, in turn rotating pivot plate 4A forward thus increasing the throttle of the aircraft by moving the radio control transmitter gimbal forward. When the R/C Cockpit is in fixed-wing mode, handle 19A would be pushed forward causing the same effect of increasing the throttle of the aircraft.

All flight test and fine tuning of the R/C Cockpit where achieved by use of a model aircraft computer flight simulator, which employs both fixed-wing and rotary-wing aircraft in its programs.

This invention is not limited to any particular type of radio controlled, free flying, or computer generated models. Any mode 2 radio control transmitter can be retrofitted to the R/C Cockpits transmitter tray 1.

I claim:

1. An apparatus for controlling a model aircraft by moving the member of a transmitter which transmits signals to a receiver on board of the model, a base for positioning on a flat supporting surface. An operator seat attached to one end of the base. A set of foot pedals for an operator seated on said seat to reach with his feet, to have independent movement, mounted to the other end of said base. Controls that are mounted on said base between said seat and said foot pedals which are within hand reach of the operator for controlling of an aircraft, a first means for securing a two control pivoting member transmitter for actuating various parts of a model aircraft. A second means for moving one of the control members of the transmitter by causing the independent movement of each said foot pedal, a third means for moving the other control member of the transmitter via a mechanical linkage by hand control, said hand control consist of a base mounted shaft capable of radial movement.

2. The control means of the apparatus set forth in claim 1 is biased by cables that ride on pulleys that are mounted to said base.

3. The control means of the apparatus set forth in claim 1 is biased by a rod connected to on end of a rocker arm which is mounted to said base.

4. The control means of the apparatus set forth in claim 1 is biased by a ny-rod in which one end is connected to the other end of said rocker arm and the opposite end of the ny-rod is connected to a control lever which when pulled activates movement of the rocker arm.

5. A unique apparatus described in claim 1 wherein the invention is able to cater to both fixed-wing and rotary-wing aircraft with the throttle conversion unit FIG. 3 part numbers 19A, 19B and 19C.
